(19) United States
(12) Patent Application Publication
(10) Pub. No.: US 2008/0036980 A1
(43) Pub. Date: Feb. 14, 2008

(54) PATTERN FORMING METHOD AND APPARATUS USED FOR THE SAME

(75) Inventor: Taro YAMAMOTO, Koshi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/780,984

(22) Filed: Jul. 20, 2007

(30) Foreign Application Priority Data
Aug. 8, 2006 (JP) 2006-215725

(51) Int. Cl. G03B 27/42; G03C 5/04

(52) U.S. Cl. 355/30; 355/77; 430/396

(57) ABSTRACT

A pattern forming method includes performing resist coating on a substrate, thereby forming a resist film; performing immersion light exposure in accordance with a predetermined pattern on the resist film formed on the substrate, while immersing the resist film in a high refractive index liquid having a refractive index higher than water; and performing development of the resist film after the immersion light exposure. Further, this method includes performing cleaning on the substrate by use of a cleaning liquid containing the same active ingredient as the high refractive index liquid in at least one of a first period after formation of the resist film and before the immersion light exposure and a second period after the immersion light exposure and before the development.

### BACKGROUND OF THE INVENTION

1. Field of the Invention

The present invention relates to a pattern forming method and an apparatus used for the method, wherein the method includes an immersion light exposure process arranged to subject a resist film formed on a substrate to light exposure in accordance with a predetermined pattern while immersing the resist film in a high refractive index liquid.

2. Description of the Related Art

In the process of manufacturing semiconductor devices, photolithography techniques are used for forming circuit patterns on semiconductor wafers. Where a circuit pattern is formed by use of photolithography, the process steps are performed, as follows. Specifically, a resist liquid is first applied to a semiconductor wafer to form a resist film. Then, the resist film is irradiated with light to perform light exposure on the resist film in accordance with the circuit pattern. Then, the resist film is subjected to a developing process.

In recent years, the integration degree of semiconductor devices becomes increasingly higher to improve the operation speed and so forth. Accordingly, photolithography techniques are required to increase the miniaturization level of circuit patterns formed on semiconductor wafers. As a photolithography technique for realizing a high resolution of a 45-nm node level, there has been proposed the following immersion light exposure (for example, see U.S. Patent Application Publication No. US 2006/0231206 A1). In this immersion light exposure, a light exposure liquid, such as purified water, having a refractive index higher than air is supplied between the semiconductor wafer and light exposure projection lens. The wavelength of light radiated from the projection lens is shortened by means of the refractive index of the light exposure liquid, so that the line width obtained by the light exposure is decreased. Further, in order to attain a higher resolution, there has been proposed a technique for performing immersion light exposure while using a high refractive index liquid as a light exposure liquid (see “Development of new high refractive index liquid (Delphi) for next-generation immersion light exposure in semiconductor manufacturing,—realizing micro-fabrication of 32 nano-meter line width—,” Sep. 12, 2005, Mitsui Chemicals, Inc. (authorship unknown); Internet [mitsui-chem.co.jp/whats/2005_{—}0912.htm]). According to this technique, the high refractive index liquid is formed of a liquid compound comprising a cyclic hydrocarbon skeleton and having a higher refractive index than purified water, with which a high resolution of a 32-nm node level is realized.

In general, where circuit patterns are formed by use of immersion light exposure, cleaning of a semiconductor wafer is performed by use of a cleaning liquid, such as purified water, before and after immersion light exposure (for example, see Jpn. Pat. Appln. KOKAI Publication No. 2006-80403). Cleaning performed before immersion light exposure is conceived to improve the affinity relative to the light exposure liquid. Cleaning performed after immersion light exposure is conceived to remove part of the light exposure liquid left on the semiconductor wafer.

However, where a high refractive index liquid is used as a light exposure liquid, as described above, the light exposure liquid comes to be greatly different in physicality from a conventional cleaning liquid, such as purified water, used before and after immersion light exposure. Consequently, in cleaning performed before the immersion light exposure, the resist film may suffer process faults, such as bubbles and liquid residues, generated during the immersion light exposure due to the residual part of the cleaning liquid. Further, in cleaning performed after the immersion light exposure, process faults, such as lack of process uniformity, may be caused.

### BRIEF SUMMARY OF THE INVENTION

An object of the present invention is to provide a pattern forming method that can prevent a substrate from suffering process faults generated thereon. Another object of the present invention is to provide an apparatus used for the pattern forming method and a computer readable storage medium that stores a control program for executing the pattern forming method.

According to a first aspect of the present invention, there is provided a pattern forming method comprising: performing resist coating on a substrate, thereby forming a resist film; performing immersion light exposure in accordance with a predetermined pattern on the resist film formed on the substrate, while immersing the resist film in a high refractive index liquid having a refractive index higher than water; performing development of the resist film after the immersion light exposure; and performing cleaning on the substrate by use of a cleaning liquid containing the same active ingredient as the high refractive index liquid in at least one of a first period after formation of the resist film and before the immersion light exposure and a second period after the immersion light exposure and before the development.

In the first aspect, the cleaning liquid may contain as a main component (at 50% or more) the same liquid as the high refractive index liquid. The cleaning liquid may consist essentially of the same liquid as the high refractive index liquid. The high refractive index liquid may have a refractive index of not less than 1.5. The high refractive index liquid may be a compound comprising a cyclic hydrocarbon skeleton. The cleaning may be performed in both of the first and second periods. The cleaning may comprise rotating the substrate in a horizontal state, while supplying the cleaning liquid onto a main surface of the substrate.

According to a second aspect of the present invention, there is provided an apparatus used for a pattern forming method that includes performing immersion light exposure in accordance with a predetermined pattern on a resist film formed on the substrate, while immersing the resist film in a high refractive index liquid having a refractive index higher than water, the apparatus comprising: a resist coating section configured to perform resist coating on the substrate to form the resist film; a development section configured to perform development of the resist film after the immersion light exposure; and a cleaning section configured to perform cleaning on the substrate by use of a cleaning liquid containing the same active ingredient as the high refractive index liquid in at least one of a first period after formation of the resist film and before the immersion light exposure and a second period after the immersion light exposure and before the development.

In the second aspect, the apparatus may further comprise an immersion light exposure section configured to perform the immersion light exposure. The cleaning section may comprise first and second cleaning sections configured to perform the cleaning in the first and second periods, respectively. The cleaning section may comprise a spin chuck configured to hold and rotate the substrate in a horizontal state and a cleaning liquid supply mechanism configured to supply the cleaning liquid onto the main surface of the substrate held by the spin chuck, such that the cleaning is performed on the substrate while the cleaning liquid is supplied from the cleaning liquid supply mechanism onto the substrate rotated by the spin chuck. The cleaning liquid may contain as a main component (at 50% or more) the same liquid as the high refractive index liquid. The cleaning liquid may consist essentially of the same liquid as the high refractive index liquid. The high refractive index liquid may have a refractive index of not less than 1.5. The high refractive index liquid may be a compound comprising a cyclic hydrocarbon skeleton.

According to a third aspect of the present invention, there is provided a computer readable storage medium that stores a control program for execution on a computer, the control program, when executed, causing the computer to control a processing apparatus to conduct a pattern forming method comprising: performing resist coating on a substrate, thereby forming a resist film; performing immersion light exposure in accordance with a predetermined pattern on the resist film formed on the substrate, while immersing the resist film in a high refractive index liquid having a refractive index higher than water; performing development of the resist film after the immersion light exposure; and performing cleaning on the substrate by use of a cleaning liquid containing the same active ingredient as the high refractive index liquid in at least one of a first period after formation of the resist film and before the immersion light exposure and a second period after the immersion light exposure and before the development.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view schematically showing the layout of a pattern forming apparatus according to an embodiment of the present invention;

FIG. 2 is a perspective view schematically showing the pattern forming apparatus;

FIG. 3 is a perspective view schematically showing an interface station used in the pattern forming apparatus;

FIG. 4 is a block diagram showing a control system used in the pattern forming apparatus;

FIG. 5 is a flow chart showing a pattern forming method performed in the pattern forming apparatus;

FIG. 6 is a sectional view schematically showing the immersion light exposure section of a light exposure apparatus used in the pattern forming apparatus; and

FIGS. 7A and 7B are sectional views schematically showing a pre-cleaning unit used in the pattern forming apparatus.

### DETAILED DESCRIPTION OF THE INVENTION

An embodiment of the present invention will now be described with reference to the accompanying drawings. In the following description, the constituent elements having substantially the same function and arrangement are denoted by the same reference numerals, and a repetitive description will be made only when necessary.

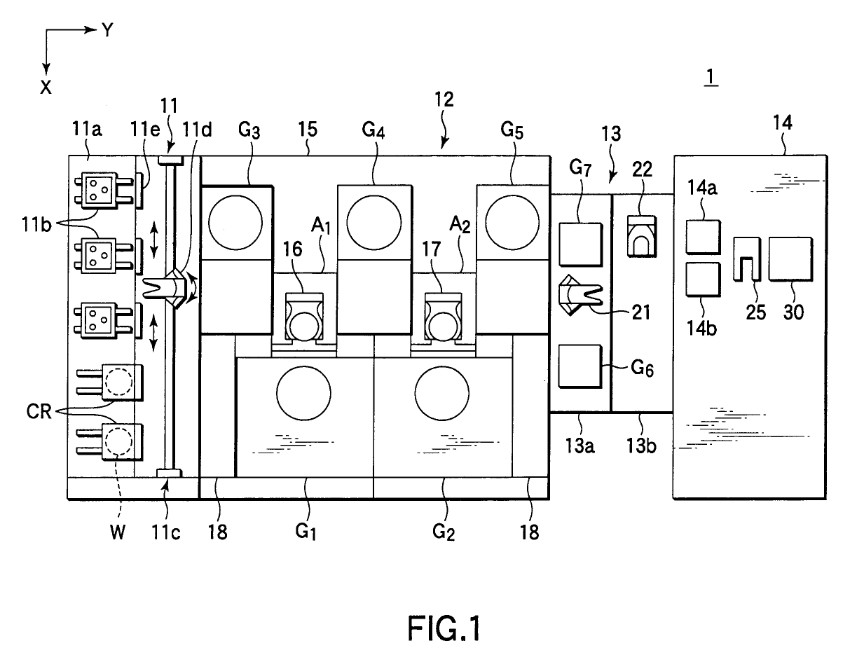

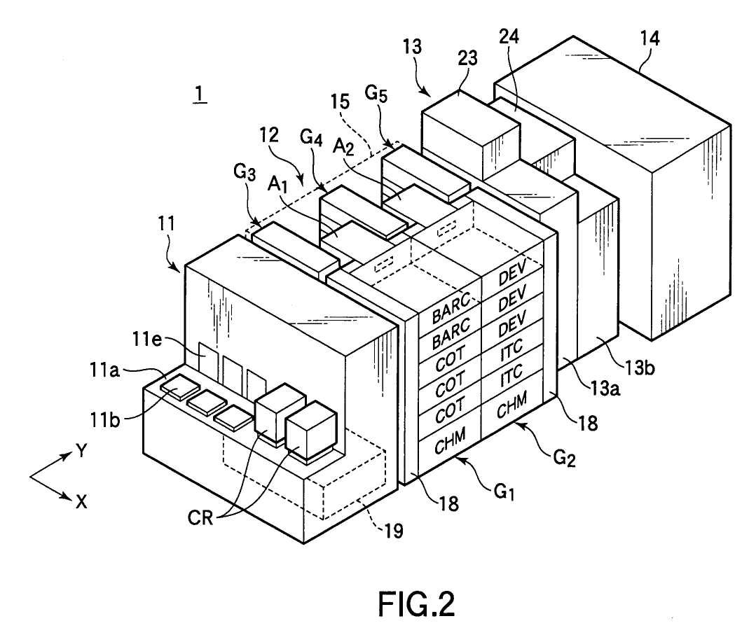

FIG. 1 is a plan view schematically showing the layout of a pattern forming apparatus according to an embodiment of the present invention. FIG. 2 is a perspective view schematically showing the pattern forming apparatus. The pattern forming apparatus 1 is designed to form a predetermined resist pattern on a semiconductor substrate or wafer W. This pattern forming apparatus 1 includes a cassette station 11 used as a transfer station for wafers W, a process station 12 comprising a plurality of processing units each for performing a predetermined process on a wafer W, a light exposure apparatus 14 for performing a light exposure process on a wafer W, and an interface station 13 for transferring wafers W between the process station 12 and light exposure apparatus 14. The cassette station 11, process station 12, interface station 13, and light exposure apparatus 14 are arrayed in series in this order in the longitudinal direction of the pattern forming apparatus 1 (Y-direction).

The cassette station 11 includes a cassette table 11a for placing thereon wafer cassettes (CR) each storing a plurality of, such as 13, wafers W, and a wafer transfer mechanism 11c for transferring wafers W between the wafer cassettes (CR) placed on the cassette table 11a and a transition unit located in a third processing unit group G₃ in the process station 12 described later. The cassette table 11a and wafer transfer mechanism 11c are arrayed in series in this order in the Y-direction. The cassette table 11a has a plurality of, such as 5, positioning portions 11b each for positioning a wafer cassette (CR), arrayed thereon in the width direction of the pattern forming apparatus 1 (X-direction). A wafer cassette (CR) is placed at each of the positioning portions 20a such that its transfer port faces an opening/closing portion 11e formed in a wall of the casing of the wafer transfer mechanism 11c. The wafer transfer mechanism 11c includes a transfer pick lid disposed in the casing for handling wafers W, so that the wafers W are transferred by the transfer pick lid between the wafer cassettes (CR) on the cassette table 11a and the transition unit.

The process station 12 is arranged in a casing 15, on the front side of which (lower side in FIG. 1), the process station 12 includes a first processing unit group G₁ and a second processing unit group G₂ arrayed in this order from the cassette station 11 toward the interface station 13. On the rear side of the casing 15 (upper side in FIG. 1), the process station 12 includes a third processing unit group G₃, a fourth processing unit group G₄, and a fifth processing unit group G₅ arrayed in this order from the cassette station 11 toward the interface station 13. Further, the process station 12 includes a first main transfer section A₁ interposed between the third processing unit group G₃ and fourth processing unit group G₄, and a second main transfer section A₂ interposed between the fourth processing unit group G₄ and fifth processing unit group G₅.

The first processing unit group G₁ includes a plurality of processing units stacked one on the other, which are formed of, e.g., two bottom coating units (BARC) for forming an anti-reflective coating that prevents reflection of light during light exposure on a wafer W, and three resist coating units (COT) for performing resist coating on the surface of a wafer W to form a resist film. The second processing unit group G₂ includes a plurality of processing units stacked one on the other, which are formed of, e.g., three development units (DEV) for developing a resist film formed on a wafer W after light exposure, and two top coating units (ITC) for supplying a protection liquid onto the surface of a resist film formed on a wafer W to form a protection film, which is used as a liquid repellent film repellent to an immersion light exposure liquid described later.

Each of the third processing unit group G₃, fourth processing unit group G₄, and fifth processing unit group G₅ includes a plurality of, such as 10, processing units stacked one on the other, which are formed of, e.g., an adhesion unit for performing a hydrophobic process on a wafer W, a pre-baking unit for performing a heating process on a wafer W after resist coating, a post-baking unit for performing a heating process on a wafer W after development, a post-exposure baking unit for performing a heating process on a wafer W after light exposure and before development, and so forth. The third processing unit group G₃ includes a transition unit through which wafers W are transferred between the cassette station 11 and first main transfer section A₁. The fifth processing unit group G₅ includes a transition unit through which wafers W are transferred between the second main transfer section A₂ and a first wafer transfer member 21 used in the interface station 13 described later.

The first main transfer section A₁ is provided with a first main wafer transfer arm 16 for handling wafers W, which can selectively access the units located in the first processing unit group G₁, third processing unit group G₃, and fourth processing unit group G₄. The second main transfer section A₂ is provided with a second main wafer transfer arm 17 for handling wafers W, which can selectively access the units located in the second processing unit group G₂, fourth processing unit group G₄, and fifth processing unit group G₅.

Temperature/humidity adjusting units 18 are respectively disposed between the first processing unit group G₁ and cassette station 11 and between the second processing unit group G₂ and interface station 13. Each of the temperature/humidity adjusting units 18 includes a temperature adjusting device for process liquids to be supplied to the first and second processing unit groups G₁ and G₂, and a duct for adjustment of temperature and humidity. Chemical unit (CHM) are respectively disposed below the first and second processing unit groups G₁ and G₂, for supplying chemical solutions to the first and second processing unit groups G₁ and G₂.

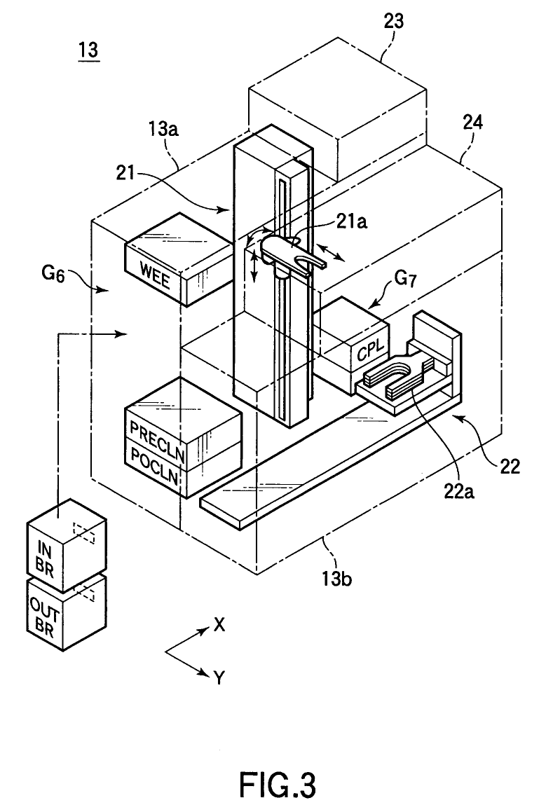

FIG. 3 is a perspective view schematically showing the interface station 13 used in the pattern forming apparatus 1. The interface station 13 has a casing that defines a first interface station 13a on the process station 12 side and a second interface station 13b on the light exposure apparatus 14 side. The first interface station 13a is provided with a first wafer transfer member 21 disposed to face an opening portion of the fifth processing unit group G₅ for transferring wafers W. The second interface station 13b is provided with a second wafer transfer member 22 movable in the X-direction for transferring wafers W.

A sixth processing unit group G₆ is located on the front side of the first interface station 13a, and includes, e.g., a periphery light exposure unit (WEE), an incoming buffer cassette (INBR), an outgoing buffer cassette (OUTBR), a pre-cleaning unit (PRECLN), and a post-cleaning unit (POCLN), stacked one on the other. The periphery light exposure unit (WEE) is used for performing light exposure selectively only on the edge portion of a wafer W to remove unnecessary resist portion near the edge of the wafer. The incoming buffer cassette (INBR) is used for temporarily placing wafers W to be transferred into the light exposure apparatus 14. The outgoing buffer cassette (OUTBR) is used for temporarily placing wafers W transferred from the light exposure apparatus 14. The pre-cleaning unit (PRECLN) is used for cleaning a wafer to be transferred into the light exposure apparatus 14. The post-cleaning unit (POCLN) is used for cleaning a wafer transferred from the light exposure apparatus 14. A seventh processing unit group G₇ is located on the rear side of the first interface station 13a, and includes, e.g., two high-precision temperature adjusting units (CPL), stacked one on the other, for adjusting the temperature of a wafer W with high precision.

The first wafer transfer member 21 includes a fork 21a for transferring wafers W. The fork 21a can selectively access the units located in the fifth processing unit group G₅, sixth processing unit group G₆, and seventh processing unit group G₇ to transfer wafers W between these units.

The second wafer transfer member 22 includes a fork 22a for transferring wafers W. The fork 22a can selectively access the pre-cleaning unit (PRECLN) and post-cleaning unit (POCLN) of the sixth processing unit group G₆, the units located in the seventh processing unit group G₇, and an incoming stage 14a and an outgoing stage 14b of the light exposure apparatus 14 described later to transfer wafers W between these portions.

A gas flow adjusting section 23 is disposed on top of the first interface station 13a to adjust the gas flow inside the first interface station 13a or interface station 13. A humidifier section 24 is disposed on top of the second interface station 13b to humidify the atmosphere inside the second interface station 13b or interface station 13 not to dry a wafer W transferred from the light exposure apparatus.

The light exposure apparatus 14 includes an incoming stage 14a for placing thereon wafers W transferred from the interface station 13, and an outgoing stage 14b for placing thereon wafers W to be transferred to the interface station 13. The light exposure apparatus 14 further includes an immersion light exposure section 30 structured to subject a resist film formed on a wafer W to light exposure in accordance with a predetermined pattern, while immersing the resist film in a high refractive index liquid having a higher refractive index than water or purified water. A wafer transfer mechanism 25 is disposed to transfer wafers W between the incoming stage 14a, immersion light exposure section 30, and outgoing stage 14b. The light exposure apparatus 14 will be explained in detail later.

Each of the pre-cleaning unit (PRECLN) and post-cleaning unit (POCLN) is structured to perform cleaning (or rinsing) on a wafer W by use of a high refractive index liquid as a cleaning liquid. This high refractive index liquid contains the same active ingredient as the high refractive index liquid used in the immersion light exposure section 30, and preferably consists essentially of the same components as the high refractive index liquid used in the immersion light exposure section 30. In other words, the cleaning liquid used in these units may contain as the main component (i.e., at 50% or more) the same high refractive index liquid as that used in the immersion light exposure section 30, and preferably consists essentially of the same high refractive index liquid as that used in the immersion light exposure section 30. The pre-cleaning unit (PRECLN) and post-cleaning unit (POCLN) will be explained in detail later.

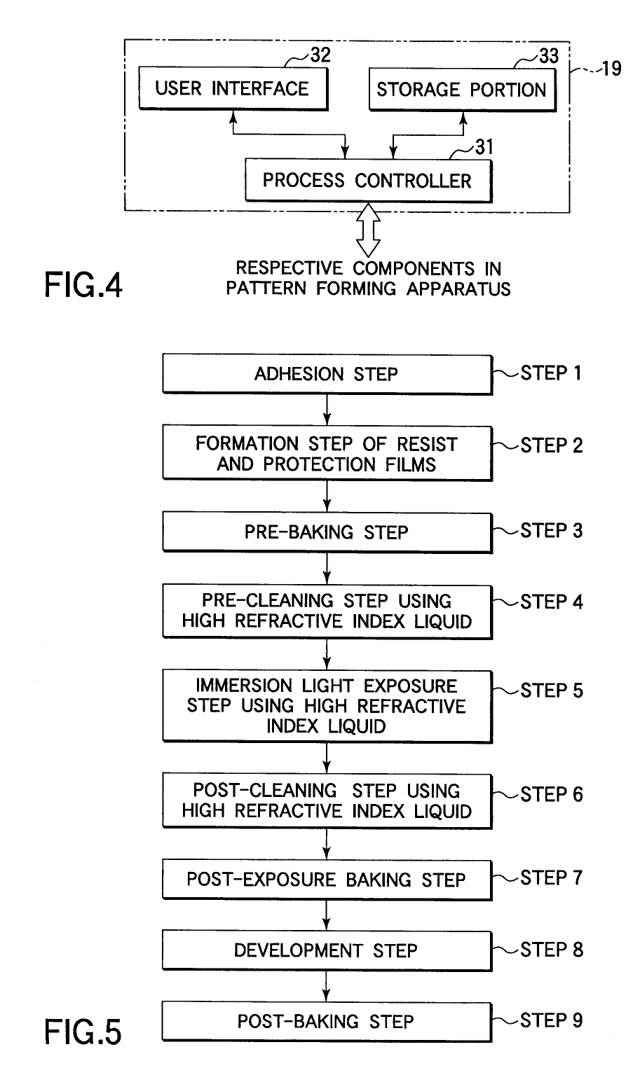

As shown in FIG. 2, a control section 19 is located below the cassette station 11 and is used for controlling this pattern forming apparatus 1, as a whole. As shown in FIG. 4, this control section 19 includes a process controller 31 comprising a micro processor (computer). The process controller 31 is connected to a user interface 32, which includes, e.g., a keyboard and a display, wherein the keyboard is used for a process operator to input commands for operating the pattern forming apparatus 1, and the display is used for showing visualized images of the operational status of the pattern forming apparatus 1. Further, the process controller 31 is connected to the storage portion 33, which stores recipes with control programs and process condition data recorded therein, for realizing various processes performed in the pattern forming apparatus 1 under the control of the process controller 31.

A required recipe is retrieved from the storage portion 33 and executed by the process controller 31 in accordance with an instruction or the like input through the user interface 32. Consequently, each of various predetermined processes is performed in the pattern forming apparatus 1 under the control of the process controller 31. Recipes may be stored in a computer readable storage medium, such as a CD-ROM, hard disk, or flash memory. Further, recipes may be transmitted from another apparatus through, e.g., a dedicated line, as needed.

Next, an explanation will be given of process steps performed in the pattern forming apparatus 1. FIG. 5 is a flow chart showing a pattern forming method performed in the pattern forming apparatus.

In the pattern forming apparatus 1 arranged as described above, wafers W are taken out one by one from a wafer cassette (CR) by the transfer pick 11d of the wafer transfer mechanism 11c. A wafer W thus taken out is transferred by the transfer pick 11d into the transition unit of the third processing unit group G₃ of the process station 12. Then, the wafer W is sequentially transferred by the first and second main transfer sections A₁ and A₂ through predetermined units in the first to fifth processing unit groups G₁ to G₅, so that the wafer W is subjected to a series of processes in accordance with the order prescribed in the recipe. For example, the wafer W is subjected to an adhesion step (STEP 1) in the adhesion unit, a film formation step (STEP 2) of a resist film in one of the resist coating units (COT) and a protection film in one of the top coating units (ITC), and a pre-baking step (STEP 3) in the pre-baking unit in this order. In place of the adhesion process, the wafer W may be subjected to formation of an anti-reflective coating in one of the bottom coating units (BARC), or formation of an anti-reflective coating on a resist film and formation of a protection film on the anti-reflective coating.

After the wafer W is subjected to a series of processes in the process station 12, the wafer W is transferred to the transition unit of the fifth processing unit group G₅. Then, the wafer W is transferred by the first wafer transfer member 21 to the pre-cleaning unit (PRECLN), in which the wafer W is subjected to a pre-cleaning step (STEP 4) by use of a high refractive index liquid. As needed, it may be arranged such that, before the wafer W is transferred to the pre-cleaning unit (PRECLN), the wafer W is transferred to the periphery light exposure unit (WEE), in which the wafer W is subjected to periphery light exposure, and is then transferred to the incoming buffer cassette (INBR).

After the pre-cleaning step is finished in the pre-cleaning unit (PRECLN), the wafer W is transferred by the second wafer transfer member 22 to the high-precision temperature adjusting unit (CPL), in which the wafer W is adjusted to a predetermined temperature. Then, the wafer W is transferred by the second wafer transfer member 22 to the incoming stage 14a of the light exposure apparatus 14. Then, the wafer W is transferred by the wafer transfer mechanism 25 to the immersion light exposure section 30, in which the resist film formed on the wafer W is subjected to an immersion light exposure step (STEP 5) by use of a high refractive index liquid.

After the immersion light exposure step is finished in the immersion light exposure section 30, the wafer W is transferred by the wafer transfer mechanism 25 to the outgoing stage 14b. Then, the wafer W is transferred by the second wafer transfer member 22 to the post-cleaning unit (POCLN), in which the wafer W is subjected to a post-cleaning step (STEP 6) by use of a high refractive index liquid. Thereafter, the wafer W is transferred by the first wafer transfer member 21 to the transition unit of the fifth processing unit group G₅. Then, the wafer W is sequentially transferred by the first and second main transfer sections A₁ and A₂ through predetermined units in the first to fifth processing unit groups G₁ to G₅, so that the wafer W is subjected to a series of processes in accordance with the order prescribed in the recipe. For example, the wafer W is subjected to a post-exposure baking step (STEP 7) in the post-exposure baking unit, a development step (STEP 8) in one of the development units (DEV), and a post-baking step (STEP 9) in the post-baking unit in this order. Then, the wafer W is transferred to the transition unit of the third processing unit group G₃, and is further transferred to a wafer cassette (CR) placed on the cassette station 11.

According to this embodiment, after a film, such as a resist film, is formed on a wafer W and before the resist film is subjected to the immersion light exposure by use of a high refractive index liquid as a light exposure liquid, cleaning is performed on the wafer W in the pre-cleaning unit (PRECLN) by use a high refractive index liquid as the cleaning liquid. This high refractive index liquid or cleaning liquid contains the same active ingredient as the light exposure liquid, so that it has physicality very close to, and preferably the same as, that of the light exposure liquid. Consequently, the affinity of the wafer W relative to the light exposure liquid used in the immersion light exposure is improved, so that the resist film is prevented from suffering bubbles and liquid residues generated during the immersion light exposure due to the residual part of the cleaning liquid, which are brought about by the difference in physicality between the cleaning liquid and light exposure liquid. Further, after the immersion light exposure and before the development, cleaning is performed on the wafer W in the post-cleaning unit (POCLN) by use a high refractive index liquid as the cleaning liquid. This high refractive index liquid or cleaning liquid also contains the same active ingredient as the light exposure liquid, so that it has physicality very close to, and preferably the same as, that of the light exposure liquid. Consequently, even where the high refractive index liquid used as the light exposure liquid has a high viscosity and adheres to the wafer W during the immersion light exposure, the residual part of the light exposure liquid can be satisfactorily removed by means of the adhesive force of the cleaning liquid having physicality very close to, and preferably the same as, that of the light exposure liquid. It follows that the wafer W or resist film are prevented from suffering process faults generated thereon, such as lack of process uniformity, so that the quality of a resist pattern formed on the wafer W is improved.

The high refractive index liquid used in this embodiment has a refractive index higher than purified water (having a refractive index of 1.44), and preferably has a refractive index of not less than 1.5. For example, this liquid is a liquid compound comprising a cyclic hydrocarbon skeleton (having a refractive index of 1.63). For example, Jpn. Pat. Appln. KOKAI Publication No. 2006-140429 discloses high refractive index liquids which are preferably usable as the high refractive index liquid according to this embodiment.

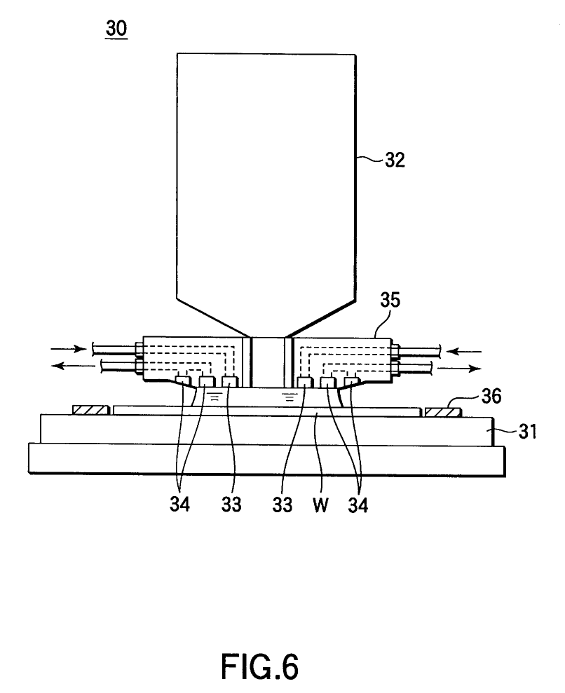

Next, a detailed explanation will be given of the immersion light exposure section 30 of the light exposure apparatus 14. FIG. 6 is a sectional view schematically showing the immersion light exposure section 30 of the light exposure apparatus 14 used in the pattern forming apparatus 1.

The immersion light exposure section 30 includes an openable chamber (not shown) and the following members located in the chamber, such as a stage 31 for placing thereon a wafer W. A projection lens 32 is disposed to project a mask pattern image, obtained by irradiation with light exposure light from a light source (not shown), onto the wafer W placed on the stage 31 to perform light exposure. Supply ports 33 and collection ports 34 for the high refractive index liquid used as a light exposure liquid are formed in a light exposure liquid distribution member 35, such that the light exposure liquid is supplied from the supply ports 33 into the gap between the wafer W placed on the stage 31 and the projection lens 32, and is then collected from the collection ports 34.

The stage 31 is movable in a horizontal direction and slightly rotatable. The stage 31 is provided with an annular projection to surround the wafer W placed thereon, so that the wafer W is held by the annular projection 36, and the light exposure liquid supplied on the wafer W is prevented from flowing out. The projection lens 32 magnifies and projects a mask pattern image at a predetermined magnification onto the wafer W for light exposure. As the light exposure light emitted from the light source, far ultraviolet light, such as KrF excimer laser light, or vacuum ultraviolet light, such as ArF excimer laser light, is used. The light exposure liquid distribution member 35 has an annular shape to surround the distal or lower end of the projection lens 32. The supply ports 33 and collection ports 34 are formed at intervals in annular directions on the bottom of the distribution member 35. Accordingly, the light exposure liquid is supplied from the supply ports 33, while the light exposure liquid thus supplied is collected from the collection ports 34 by means of, e.g., suction.

The immersion light exposure section 30 having the structure described above is operated, as follows. Specifically, when a wafer W is placed on the stage 31 by the wafer transfer mechanism 25, the stage 31 and/or mask are horizontally moved, as needed. Further, the high refractive index liquid is supplied from the supply ports 33 of the light exposure liquid distribution member 35 into the gap between the wafer W and projection lens 32. In this state, a mask pattern image is projected from the projection lens 32 onto the wafer W to subject the wafer W to an immersion light exposure process. At this time, the high refractive index liquid supplied into the gap between the wafer W and projection lens 32 is collected through the collection ports 34. In this embodiment, since the high refractive index liquid is used for the immersion light exposure, the wavelength of the light exposure light is significantly shortened, thereby attaining a high resolution. After the immersion light exposure is performed for a predetermined time, supply of the light exposure liquid is stopped, and the wafer W is transferred from the stage 31 to the outgoing stage 14b by the wafer transfer mechanism 25.

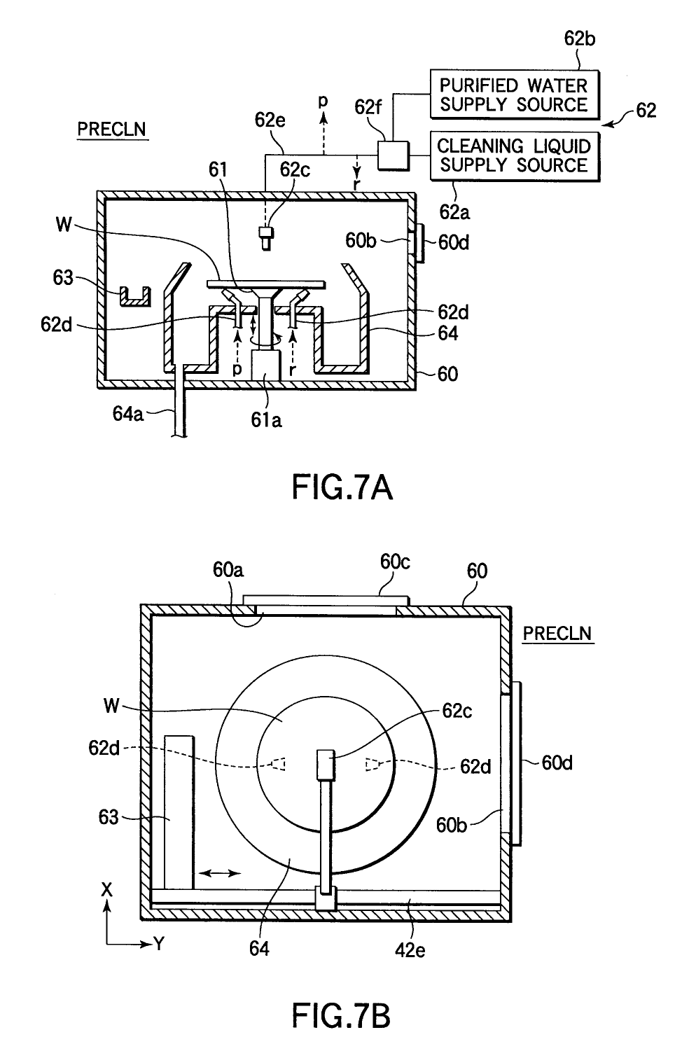

Next, a detailed explanation will be given of the pre-cleaning unit (PRECLN). FIGS. 7A and 7B are sectional views schematically showing the pre-cleaning unit (PRECLN) used in the pattern forming apparatus 1.

The pre-cleaning unit (PRECLN) includes a chamber 60 for accommodating a wafer W, and a spin chuck 61 located inside the chamber 60 to hold and rotate the wafer W in a horizontal state. A process liquid supply mechanism 62 (cleaning liquid supply mechanism) is disposed to supply process liquids, such as a cleaning liquid, onto the wafer W held by the spin chuck 61. A cup body 64 is disposed to receive process liquids, such as a cleaning liquid, spilt from the wafer W and/or thrown off from the wafer W.

The chamber 60 has transfer ports 60a and 60b for transferring the wafer W formed in, e.g., sidewalls facing the first wafer transfer member 21 and second wafer transfer member 22. The transfer port 60a and 60b are respectively provided with shutters 60c and 60d for opening/closing them. The spin chuck 61 is movable up and down, and is configured to hold the wafer W from the lower surface thereof by a vacuum attraction force, and to rotate the wafer W held in a horizontal state by a driving source 61a, such as a motor.

The process liquid supply mechanism 62 includes a cleaning liquid supply source 62a for supplying a cleaning liquid, and a purified water supply source 62b for supplying purified water. An upper nozzle 62c is disposed for the cleaning liquid supplied from the cleaning liquid supply source 62a and purified water supplied from the purified water supply source 62b to be delivered from above onto the upper surface (front side) of the wafer W held by the spin chuck 61. Lower nozzles 62d are disposed for the cleaning liquid supplied from the cleaning liquid supply source 62a and purified water supplied from the purified water supply source 62b to be delivered from below onto the peripheral portion of the lower surface (back side) of the wafer W held by the spin chuck 61. The cleaning liquid supplied from the cleaning liquid supply source 62a and purified water supplied from the purified water supply source 62b flow through conduit lines 62e to the upper nozzle 62c and lower nozzles 62d. A flow rate adjusting mechanism 62f including, e.g., a valve is disposed to switch the cleaning liquid and purified water to be supplied through the conduit line 62e, and to adjust the flow rate of the cleaning liquid or purified water supplied through the conduit line 62e. The proximal end portion of the upper nozzle 62c is attached to a guide rail 42e extending in the Y-direction inside the chamber 60 such that,the upper nozzle 62c is movable in the Y-direction along the guide rail 42e, and is also movable up and down. A plurality of lower nozzles 62d are arrayed at intervals in an annular direction about the spin chuck 61, for example. Each of the lower nozzles 62d is inclined upward and outward relative to the wafer W, so that a process liquid, such as the cleaning liquid, is delivered onto the peripheral portion of the wafer W radially outward from blow. A waiting position 63 is prepared to set the upper nozzle 62c in a waiting state.

The cup body 64 is opened upward and is configured to surround the wafer W when the spin chuck 61 holding the wafer W is moved down. Further, the upper end side of the cup body 64 is inclined upward and inward to directly receive a process liquid spouted from the lower nozzle 62d, as well as a process liquid spilt from the wafer W and/or thrown off from the wafer W. A collection line 64a for collecting a process liquid received in the cup body 64 is connected to the bottom wall of the cup body 64, so that the process liquid collected from the cup body 64 into the collection line 64a can be recycled or discarded.

The post-cleaning unit (POCLN) has a structure equivalent to the pre-cleaning unit (PRECLN).

The pre-cleaning unit (PRECLN) having the structure described above is operated, as follows. Specifically, when a wafer W is transferred by the first wafer transfer member 21 through the transfer port 60a into the chamber 60, the spin chuck 61 is moved up to catch the wafer W by a vacuum attraction force and thereby hold the wafer W on the spin chuck 61. Then, the shutter 60c is moved to close the transfer port 60a, and the spin chuck 61 is moved down so that the wafer W is surrounded by the cup body 64. Then, while the wafer W is rotated by the spin chuck 61, the cleaning liquid is supplied from the process liquid supply mechanism 62 onto the wafer W to clean the wafer W. At this time, the cleaning liquid is spread over the wafer W, so the affinity of the wafer W relative to the high refractive index liquid is improved. Then, without supply of the cleaning liquid from the process liquid supply mechanism 62, the wafer W is rotated by the spin chuck 61 to throw off the liquid and dry the wafer W. After the throwing off and drying, the spin chuck 61 stops being rotated and is moved up. Then, the shutter 60d is moved to open the transfer port 60b, and the wafer W is transferred by the second wafer transfer member 22 out of the chamber 60 through the transfer port 60b.

On the other hand, the post-cleaning unit (POCLN) is operated, as follows. Specifically, when a wafer W is transferred by the second wafer transfer member 22 through the transfer port 60b into the chamber 60, the wafer W is held by the spin chuck 61. Then, the transfer port 60b is closed, and the spin chuck 61 is moved down. Then, while the wafer W is rotated by the spin chuck 61, the cleaning liquid is supplied from the process liquid supply mechanism 62 onto the wafer W to clean the wafer W. This cleaning is conceived to remove the residual part of the high refractive index liquid adhering to the wafer W due to use thereof for the immersion light exposure in the immersion light exposure section 30. At this time, the residual liquid is removed under the action of a spouting pressure caused by the cleaning liquid from the upper nozzle 62c and lower nozzle 62d, an adhesive force applied thereon by the cleaning liquid, and a centrifugal force caused by rotation of the spin chuck 61. Then, while the wafer W is rotated by the spin chuck 61, purified water is supplied from the process liquid supply mechanism 62 onto the wafer W to rinse the wafer W. Further, without supply of purified water from the process liquid supply mechanism 62, the wafer W is rotated by the spin chuck 61 to throw off the liquid and dry the wafer W. After the throwing off and drying, the spin chuck 61 stops being rotated and is moved up. Then, the shutter 60c is moved to open the transfer port 60a, and the wafer W is transferred by the first wafer transfer member 21 out of the chamber 60 through the transfer port 60a.

As described above, each of the pre-cleaning unit (PRECLN) and post-cleaning unit (POCLN) is configured to clean the wafer W, while a wafer W is held and rotated by the spin chuck 61 in a horizontal state, and a cleaning liquid is spouted onto the front side of the wafer W and the peripheral portion of the back side thereof from the upper nozzle 62c and lower nozzles 62d of the process liquid supply mechanism 62. Accordingly, in the case of the pre-cleaning unit (PRECLN), the cleaning liquid is spread essentially uniformly all over the wafer W. Further, in the case of the post-cleaning unit (POCLN), the residual part of the high refractive index liquid adhering to the wafer W due to use thereof for the immersion light exposure in the immersion light exposure section 30 is effectively removed under the action of a spouting pressure caused by the cleaning liquid from the upper nozzle 62c and lower nozzle 62d and a centrifugal force caused by rotation of the spin chuck 61, as well as an adhesive force applied thereon by the cleaning liquid. Consequently, the wafer W is reliably prevented from suffering process faults generated thereon, such as lack of process uniformity.

According to the embodiment of the present invention, in a first period after resist film formation and before immersion light exposure, cleaning is performed on a substrate by use of a cleaning liquid containing the same active ingredient as a high refractive index liquid used in the immersion light exposure. With this cleaning before the immersion light exposure, the affinity of the substrate relative to the high refractive index liquid used in the immersion light exposure is improved, so that the resist film is prevented from suffering bubbles and liquid residues generated during the immersion light exposure. Further, in a second period after the immersion light exposure and before development, cleaning is performed on the substrate by use of a cleaning liquid containing the same active ingredient as the high refractive index liquid used in the immersion light exposure. With this cleaning after the immersion light exposure, the residual part of the high refractive index liquid adhering to the substrate due to use thereof for the immersion light exposure is satisfactorily removed, so the process uniformity or the like is less deteriorated. Consequently, the substrate is effectively prevented from suffering process faults generated thereon.

The present invention is not limited to the embodiment described above, and it may be modified in various manners. For example, in the embodiment described above, both of the pre-cleaning unit and post-cleaning unit are configured to perform cleaning on a substrate by use of a cleaning liquid containing the same active ingredient as a high refractive index liquid used in the immersion light exposure. Alternately, only one of the pre-cleaning unit and post-cleaning unit may be configured to use a cleaning liquid containing the same active ingredient as a high refractive index liquid used in the immersion light exposure, or containing such a high refractive index liquid as the main component (i.e., at 50% or more).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern forming method comprising:
performing resist coating on a substrate, thereby forming a resist film;
performing immersion light exposure in accordance with a predetermined pattern on the resist film formed on the substrate, while immersing the resist film in a high refractive index liquid having a refractive index higher than water;
performing development of the resist film after the immersion light exposure; and
performing cleaning on the substrate by use of a cleaning liquid containing the same active ingredient as the high refractive index liquid in at least one of a first period after formation of the resist film and before the immersion light exposure and a second period after the immersion light exposure and before the development.

2. The pattern forming method according to claim 1, wherein the cleaning liquid contains as a main component the same liquid as the high refractive index liquid.

3. The pattern forming method according to claim 1, wherein the cleaning liquid consists essentially of the same liquid as the high refractive index liquid.

4. The pattern forming method according to claim 1, wherein the high refractive index liquid has a refractive index of not less than 1.5.

5. The pattern forming method according to claim 4, wherein the high refractive index liquid is a compound comprising a cyclic hydrocarbon skeleton.

6. The pattern forming method according to claim 1, wherein the cleaning is performed in both of the first and second periods.

7. The pattern forming method according to claim 1, wherein the cleaning comprises rotating the substrate in a horizontal state, while supplying the cleaning liquid onto a main surface of the substrate.

8. An apparatus used for a pattern forming method that includes performing immersion light exposure in accordance with a predetermined pattern on a resist film formed on the substrate, while immersing the resist film in a high refractive index liquid having a refractive index higher than water, the apparatus comprising:
a resist coating section configured to perform resist coating on the substrate to form the resist film;
a development section configured to perform development of the resist film after the immersion light exposure; and
a cleaning section configured to perform cleaning on the substrate by use of a cleaning liquid containing the same active ingredient as the high refractive index liquid in at least one of a first period after formation of the resist film and before the immersion light exposure and a second period after the immersion light exposure and before the development.

9. The apparatus according to claim 8, further comprising an immersion light exposure section configured to perform the immersion light exposure.

10. The apparatus according to claim 8, wherein the cleaning section comprises first and second cleaning sections configured to perform the cleaning in the first and second periods, respectively.

11. The apparatus according to claim 8, wherein the cleaning section comprises a spin chuck configured to hold and rotate the substrate in a horizontal state and a cleaning liquid supply mechanism configured to supply the cleaning liquid onto the main surface of the substrate held by the spin chuck, such that the cleaning is performed on the substrate while the cleaning liquid is supplied from the cleaning liquid supply mechanism onto the substrate rotated by the spin chuck.

12. The apparatus according to claim 8, wherein the cleaning liquid contains as a main component the same liquid as the high refractive index liquid.

13. The apparatus according to claim 8, wherein the cleaning liquid consists essentially of the same liquid as the high refractive index liquid.

14. The apparatus according to claim 8, wherein the high refractive index liquid has a refractive index of not less than 1.5.

15. The apparatus according to claim 14, wherein the high refractive index liquid is a compound comprising a cyclic hydrocarbon skeleton.

16. A computer readable storage medium that stores a control program for execution on a computer, the control program, when executed, causing the computer to control a processing apparatus to conduct a pattern forming method comprising:
performing resist coating on a substrate, thereby forming a resist film;
performing immersion light exposure in accordance with a predetermined pattern on the resist film formed on the substrate, while immersing the resist film in a high refractive index liquid having a refractive index higher than water;
performing development of the resist film after the immersion light exposure; and
performing cleaning on the substrate by use of a cleaning liquid containing the same active ingredient as the high refractive index liquid in at least one of a first period after formation of the resist film and before the immersion light exposure and a second period after the immersion light exposure and before the development.
